(19) United States
(12) Patent Application Publication
(10) Pub. No.: US 2008/0309498 A1
(43) Pub. Date: Dec. 18, 2008

(54) ELECTRONIC SECURITY IDENTIFICATION DEVICE FOR PORTABLE DEVICES

(75) Inventors: Rafael G. Ramos Elizondo, Monterey, N. L. (MX); Jose Adalberto Teran Matus, San Pedro, N. L. (MX)

Correspondence Address: YOUNG & THOMPSON, 209 Madison Street, Suite 500, ALEXANDRIA, VA, 22314, US

(73) Assignee: RFID DE MEXICO S.A. DE C.V., SAN PEDRO GARZA GARCIA, N. L. (MX)

(21) Appl. No.: 11/762,178

(22) Filed: Jun. 13, 2007

(51) Int. Cl. G08B 13/14

(52) U.S. Cl. 340/572.9

(57) ABSTRACT

An electronic identification device for portable devices having a standardized rectangular security slot, such as a laptop computer, comprising anchoring means designed to be anchored in the security slot of the portable device; and electronic identification means attached to the anchoring means.

### BACKGROUND OF THE INVENTION

A. Field of the Invention

The present invention is related to security devices for electronic devices and more particularly to an electronic security identification device for portable devices provided with a standardized security slot, comprising anchoring means designed to be anchored in the security slot of the portable device and electronic identification means attached to the anchoring means.

B. Description of the Related Art

Many portable devices are provided with a standardized rectangular security slot which is mainly used for attaching an anchor to be fixed to an anchor point inside a building, for avoiding that the portable device be moved or stole from the place.

However, when it is needed to move or use the portable device within the building limits, it is necessary to provide the portable device with identification means so that, when someone try to take the portable device out from the building without authorization, the identification means are detected by sensors located at each entrance of the building, and an alarm is triggered, alerting the personnel about the non authorized exit of the portable device.

Normally the identification means comprise chips incorporated in stickers which are glued to the portable device. However, said sticker can be easily removed from the portable device.

In view of the above referred problem and considering that many portable devices already are equipped with the standardized security slot, applicant developed an electronic security identification device for portable devices provided with a security slot, comprising anchoring means designed to be anchored in the security slot of the portable device and electronic identification means attached to the anchoring means.

When the electronic identification means, which in a preferred embodiment of the invention comprises an RFID identification tag, is locked to the electronic device such as a laptop, it can be monitored inside a predetermined area for avoiding unauthorized equipment exits outside the monitoring area.

Since the RFID identification tag is locked to the security slot of the electronic device, it is very difficult to detach the RFID tag without seriously damaging the electronic device, which discourages thieves from stealing the device.

Furthermore, since the laptop tag can be permanently attached to the electronic device, it can be used to permanently track the device inside the predetermined area for controlling its use by the personnel when combined with personnel identification systems.

### SUMMARY OF THE INVENTION

It is therefore a main object of the present invention to provide an electronic security identification device for portable devices provided with a standardized security slot.

It is an additional main object of the present invention to provide an electronic security identification device for portable devices of the above disclosed nature comprising anchoring means designed to be anchored in the security slot of the portable device and electronic identification means attached to the anchoring means.

It is an additional object of the present invention to provide an electronic security identification device for portable devices of the above disclosed nature which allows that the portable electronic device can be monitored inside a predetermined area for avoiding unauthorized equipment exits outside the monitoring area.

It is still a main object of the present invention to provide an electronic security identification device for portable devices of the above disclosed nature in which an RFID identification tag is anchored to the security slot of the electronic device, thus making very difficult to detach the RFID tag without seriously damaging the electronic device, which discourages thieves from stealing the device.

These and other objects and advantages of the electronic security identification device for portable devices of the present invention will become apparent to those persons having an ordinary skill in the art, from the following detailed description of the embodiments of the invention which will be made with reference to the accompanying drawings.

### BRIEF DESCRIPTION OF THE DRAWINGS

FIG. 1 is a schematic view showing the electronic security identification device for portable devices of the present invention before the insertion in the security slot of a laptop computer.

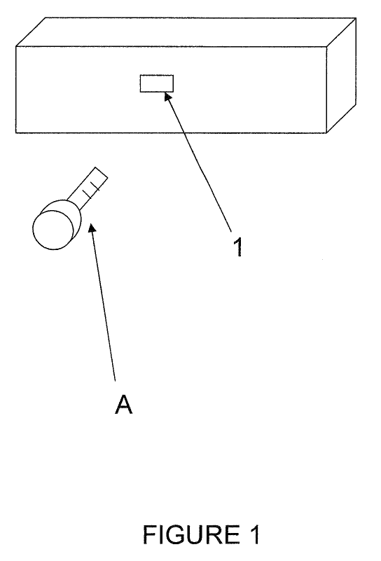

FIG. 2 is a lateral view of the electronic security identification device for portable devices of the present invention.

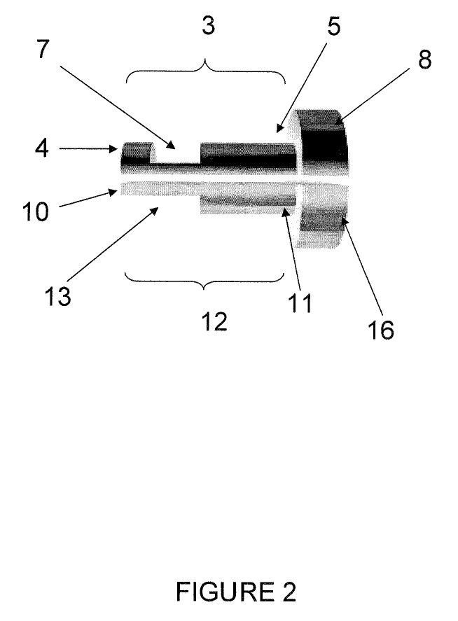

FIG. 3 is a lateral perspective view of the electronic security identification device for portable devices of the present invention.

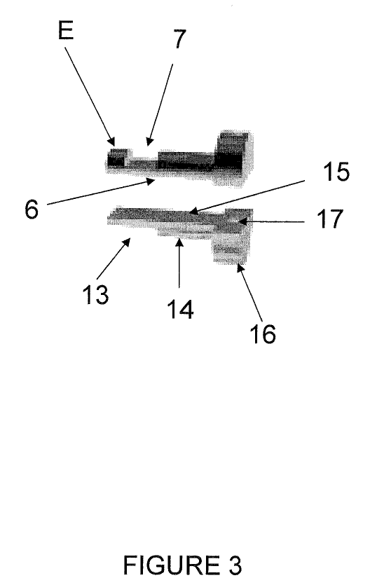

FIG. 4 is a frontal perspective view of the electronic security identification device for portable devices of the present invention.

FIG. 5, is a frontal view of the electronic security identification device for portable devices of the present invention already inserted in the security slot of a laptop computer and attaching the electronic identification means.

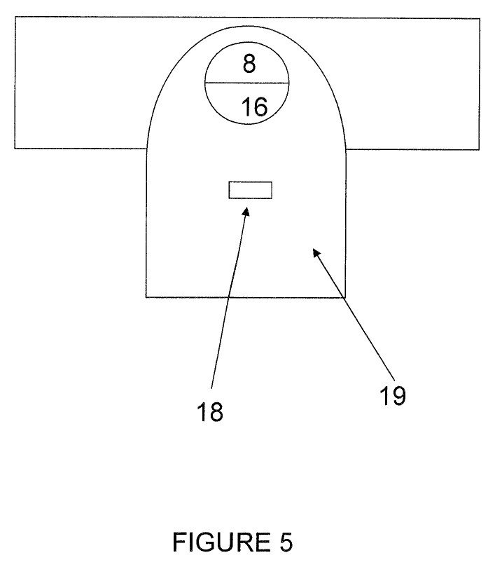

FIG. 6, is a frontal view of the electronic identification means.

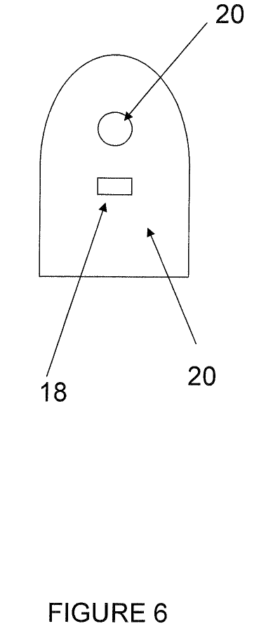

### DETAILED DESCRIPTION OF THE INVENTION

The electronic security identification device for portable devices is intended to be used in portable devices having a standardized rectangular security slot, such as a laptop computer.

The electronic security identification device for portable devices of the present invention will now be described making reference to a laptop computer having a standardized security slot, wherein said electronic identification device in it most general embodiment comprises anchoring means which are designed to be anchored in said security slot and electronic identification means attached to said anchoring means.

In a preferred embodiment the security identification device for portable devices of the present invention comprises

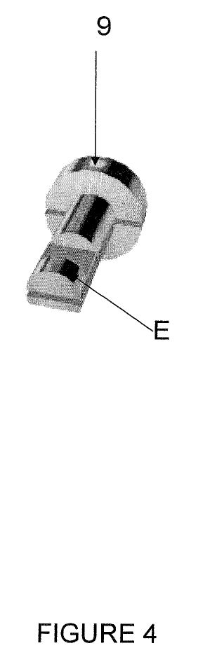

anchoring means “A” for locking in the security slot 1 of the laptop comprising:
a first locking element, comprising an enlarged semi-cylindrical main member 3 having a half-cylinder shaped cross section, a first 4 and a second 5 end and a flat side 6 and having a width so that it can be introduced into the security slot 1, including a recess 7 near its second end 5 thereof forming an engaging portion “E” and including a connection portion at its second end 5 comprising a semi-cylindrical head 8 having a half-cylinder shaped cross section including a perforation 9 beginning at an edge and diametraly crossing the cross section of the semi-cylindrical head 8 and wherein the width of said semy cylindrical head 8 is greater than the width of the main member 3;
a second locking element having a first 10 and a second end 11 and comprised by an enlarged main member 12 having a first section 13 comprised by a flat basic body a second section 14 having a half-cylinder shaped cross section and a flat side 15 and having has such a width that it can be introduced into the security slot 1, and including a connection portion at its first end comprising a semi-cylindrical head 16 having a half-cylinder shaped cross section including a perforation 17 beginning at an edge and diametraly crossing the cross section of the semi-cylindrical head 16 and wherein the width of said semy cylindrical head 16 is greater than the width of the main member 12;
wherein both locking elements are able to be locked inside said security slot 1 in such way that once both locking elements are inserted in the security slot 1, their flat sides 6, 15, lay upon each other, their half-cylinder shaped cross sections, form a complete cylinder, and their semi-cilindrical heads 8, 16, form a complete cylindrical head (as shown in FIG. 4), in which their perforations 9, 17, coincide and form a diametral perforation;
electronic identification means comprising RFID identification means 18 attached to a plastic card 19 having a perforation 20 in and end thereof, wherein the diameter of said perforation 20 is greater that the witdth of the main member 3, 12 of each locking element;
wherein the plastic card 19 is attached to the anchor means by passing the main member 3, 12 of each locking element trough said perforation 20 before inserting them in the slot 1 and after the insertion, the plastic card 19 remain retained between the computer chassis and the cylindrical head formed by both semi-cylindrical heads.

Although it was described that the anchoring means comprises the above specific design, it must be understood that it can be used any kind of anchoring means specifically designed to be anchored in the security slot of a portable device.

Also, although it was described that the plastic card 19 of the electronic identification means is attached to the anchor means by passing the main member 3, 12 of each locking element trough its perforation before inserting them in the slot 1, in other embodiments, the plastic card 19 may be attached to the anchor means by any other known means, such as a wire passing trough the plastic card perforation 20 and trough the diametral perforation formed by both locking elements.

In other embodiments, the electronic identification means may comprise an RFID chip which can be directly attached to the anchoring means by means of an adherent substance or applied inside a hard to remove cover of hardened plastic substance.

Finally it must be understood that the electronic identification device for laptops, of the present invention, is not limited exclusively to the embodiments above described and illustrated and that the persons having ordinary skill in the art can, with the teaching provided by the invention, to make modifications to the electronic identification device for laptops of present invention, which will clearly be within of the true inventive concept and of the scope of the invention which is claimed in the following claims.

We claim:

1. An electronic identification device for portable devices including a standardized security slot, comprising:
anchoring means designed to be anchored in the security slot of the portable device; and
electronic identification means attached to the anchoring means.

2. An electronic identification device for portable devices as claimed in claim 1, wherein the anchoring means comprise:
a first locking element, comprising an enlarged semi-cylindrical main member having a half-cylinder shaped cross section, a first and a second end and a flat side and having a width so that it can be introduced into the security slot, including a recess near its second end thereof forming an engaging portion and including a connection portion at its first end comprising a semi-cylindrical head having a half-cylinder shaped cross section including a perforation beginning at an edge and diametraly crossing the cross section of the semi-cylindrical head and wherein the with of said semy cylindrical is greater than the width of the main member;
a second locking element having a first and a second end and comprised by an enlarged main member having a first section comprised by a flat basic body a second section having a half-cylinder shaped cross section and a flat side and having has such a width that it can be introduced into the security slot, and including a connection portion at its first end comprising a semi-cylindrical head having a half-cylinder shaped cross section including a perforation beginning at an edge and diametraly crossing the cross section of the semi-cylindrical head and wherein the with of said semy cylindrical is greater than the width of the main member; and
wherein both locking elements are able to be locked inside said security slot in such way that once both locking elements are inserted in the security slot, their flat sides lay upon each other, the semi-cylindrical sections of their main bodies form a complete cylinder, and their semi-cilindrical heads form a complete cylindrical head, in which their perforations coincide and form a diametral perforation.

3. An electronic identification device for portable devices as claimed in claim 1, wherein the electronic identification means comprise RFID identification means attached to the anchoring means.

4. An electronic identification device for portable devices as claimed in claim 1, wherein the electronic identification means comprise RFID identification means attached to a plastic card which is attached to the anchoring means.

5. An electronic identification device for portable devices as claimed in claim 1, comprising:
anchoring means for locking in the security slot of the laptop comprising:
a first locking element, comprising an enlarged semi-cylindrical main member having a half-cylinder shaped cross section, a first and a second end and a flat side and having a width so that it can be introduced into the security slot, including a recess near its second end thereof forming an engaging portion and including a connection portion at its first end comprising a semi-cylindrical head having a half-cylinder shaped cross section including a perforation beginning at an edge and diametraly crossing the cross section of the semi-cylindrical head and wherein the with of said semy cylindrical is greater than the width of the main member;
a second locking element having a first and a second end and comprised by an enlarged main member having a first section comprised by a flat basic body a second section having a half-cylinder shaped cross section and a flat side and having has such a width that it can be introduced into the security slot, and including a connection portion at its first end comprising a semi-cylindrical head having a half-cylinder shaped cross section including a perforation beginning at an edge and diametraly crossing the cross section of the semi-cylindrical head and wherein the with of said semy cylindrical is greater than the width of the main member;
wherein both locking elements are able to be locked inside said security slot in such way that once both locking elements are inserted in the security slot, their flat sides lay upon each other, the semi-cylindrical sections of their main bodies form a complete cylinder, and their semi-cilindrical heads form a complete cylindrical head, in which their perforations coincide and form a diametral perforation;
electronic identification means comprising RFID identification means attached to a plastic card having a perforation in and end thereof, wherein the diameter of said perforation is greater that the width of the main body of each locking element;
wherein the plastic card is attached to the anchor means by passing the main body of each locking element trough said perforation before inserting them in the slot and after the insertion, the plastic card remain retained between the computer chassis and the cylindrical head formed by both semi-cylindrical heads.
